(19) United States
(12) Patent Application Publication
(10) Pub. No.: US 2012/0164938 A1
(43) Pub. Date: Jun. 28, 2012

(54) SYSTEM AND METHOD FOR PROVIDING AUGMENTED REALITY CONTENTS BASED ON BROADCASTING

(75) Inventors: Young Ho JEONG, Daejeon (KR); Chung Hyun AHN, Daejeon (KR); Jin Woo HONG, Daejeon (KR)

(73) Assignee: Electronics and Telecommunications Research Institute, Daejeon (KR)

(21) Appl. No.: 13/335,551

(22) Filed: Dec. 22, 2011

(30) Foreign Application Priority Data
Dec. 23, 2010 (KR) 10-2010-0133195

(51) Int. Cl. H04H 20/71

(52) U.S. Cl. 455/3.05

(57) ABSTRACT

Disclosed is a method of providing broadcasting-based augmented reality contents. The method includes judging whether received broadcasting contents include augmented reality associated information; requesting an augmented reality service based on the augmented reality associated information; and providing augmented reality contents according to the request.

### CROSS-REFERENCE TO RELATED APPLICATIONS

This application claims the benefits, under 35 U.S.C §119, of Korean Patent Application No. 10-2010-0133195 filed Dec. 23, 2010, the entirety of which is incorporated by reference herein.

### BACKGROUND

Exemplary embodiments relate to a system for providing augmented reality contents and a method thereof, and more particularly, relate to a system capable of providing various augmented reality contents according to a request of a user based on moving pictures or broadcasting contents transferred via a broadcasting network or an internet network.

An augmented reality service may derive from a system assisting a wiring assembly work of an airplane that was developed by the Boeing using the augmented reality technology in the early 1990s. There may be shown position-based augmented reality services using a camera, a Global Positioning System (GPS), a wideband wireless connection device, a slope sensor, a digital compass, and the like which are embedded within a up-to-date smartphone. The position-based augmented reality services using such sensors may have been evolved toward image recognition-based augmented reality services for applying it to various fields such as education, game, advertisement, sports, sightseeing, and the like. The image recognition-based augmented reality may be accomplished by directly recognizing objects taken by a camera or indirectly recognizing objects via a marker and overlaying it with augmented reality information. Since the image recognition-based augmented reality is capable of being applied to a dark room at which it is difficult to receive GPS signals, application possibility of the image recognition-based augmented reality as a new business tool may become large.

In recent, research and development on the convergence of augmented reality, capable of improving the sense of reality by making digital information be overlapped on physical reality, and the broadcasting, having strong influence on education, advertisement, sports, sightseeing contents, and the like, may be made actively. At present, augmented reality contents applied to the broadcasting may be provided to viewers in one way, with the augmented reality contents being composed with the broadcasting image. This may cause problems that an option of a viewer on augmented reality information is limited and that it is difficult to provide a bi-directional service of augmented reality-based contents. Further, although augmented reality contents are provided via a smart phone, improvement of the senses of reality and immersion of the augmented reality contents provided via a small-sized screen of the smart phone may be limited.

The above-described problems may be solved by bi-directionally providing various augmented reality contents based on broadcasting contents at all broadcasting receivers receiving broadcasting contents or at a portable terminal device.

### SUMMARY

One aspect of embodiments of the inventive concept is directed to provide a method of providing broadcasting-based augmented reality contents. The method comprises judging whether received broadcasting contents include augmented reality associated information; requesting an augmented reality service based on the augmented reality associated information; and providing augmented reality contents according to the request.

In this embodiment, the method further comprises providing information indicating that connection to the augmented reality service is possible, based on the augmented reality associated information; and confirming a request on the connection to the augmented reality service.

In this embodiment, the method further comprises making certification on the request.

In this embodiment, the method further comprises searching the augmented reality contents corresponding to the request.

In this embodiment, the method further comprises adding the augmented reality associated information to the broadcasting contents.

In this embodiment, the method further comprises searching a portable terminal device around a broadcasting receiving device receiving the broadcasting contents.

In this embodiment, the method further comprises sending the augmented reality associated information to the searched portable terminal device.

In this embodiment, the requesting is performed by the portable terminal device.

Another aspect of embodiments of the inventive concept is directed to provide a method of providing broadcasting-based augmented reality contents. The method comprises providing reference marker information to a portable terminal device; generating control information on the augmented reality contents according to the provided reference marker information; receiving and sending the control information; and requesting an augmented reality service based on the control information.

In this embodiment, the method further comprises adding augmented reality associated information including the reference marker information to broadcasting contents.

In this embodiment, the method further comprises searching the augmented reality contents corresponding to the request.

In this embodiment, the method further comprises providing the searched augmented reality contents.

In this embodiment, the generating control information comprises displaying the provided reference marker information using the portable terminal device; and moving the portable terminal device.

In this embodiment, the receiving and transmitting comprises receiving an image of the reference marker information using a camera.

Still another aspect of embodiments of the inventive concept is directed to provide a system of providing broadcasting-based augmented reality contents. The system comprises a broadcasting contents producing and transmitting device configured to add augmented reality associated information to broadcasting contents; an augmented reality contents service device configured to receive the augmented reality associated information from the broadcasting contents producing and transmitting device and to provide augmented reality contents corresponding to the augmented reality associated information; and a broadcasting receiving device configured to receive broadcasting contents to which the augmented reality associated information is added and to receive the augmented reality contents from the augmented reality contents service device.

In this embodiment, the broadcasting receiving device sends the augmented reality associated information to a portable terminal device placed around the broadcasting receiving device, and the portable terminal device requests the augmented reality contents to the augmented reality contents service device and receives the requested augmented reality contents from the augmented reality contents service device.

In this embodiment, the portable terminal device requests the augmented reality contents via the broadcasting receiving device and receives the augmented reality contents.

In this embodiment, the broadcasting receiving device provides reference marker information provided from the augmented reality contents service device to a portable terminal device placed around the broadcasting receiving device. The portable terminal device provides control information on the augmented reality contents to the augmented reality contents service device according to the provided reference marker information.

In this embodiment, the control information on the augmented reality contents is sent via the broadcasting receiving device.

In this embodiment, the augmented reality contents service device provides augmented reality contents searched according to the control information on the augmented reality contents.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating connection between systems for providing broadcasting-based augmented reality contents according to an embodiment of the inventive concept.

FIG. 2 is a block diagram schematically illustrating a broadcasting contents producing and transmitting system in FIG. 1.

FIG. 3 is a diagram for describing contents included in augmented reality associated information.

FIG. 4 is a block diagram schematically illustrating an augmented reality contents server and a broadcasting receiving device according to an embodiment of the inventive concept.

FIG. 5 is a block diagram schematically illustrating an augmented reality contents server and a broadcasting receiving device according to another embodiment of the inventive concept.

FIG. 6 is a flowchart illustrating a process of providing broadcasting-based augmented reality contents according to an embodiment of the inventive concept.

FIG. 7 is a flowchart illustrating a process of providing broadcasting-based augmented reality contents according to another embodiment of the inventive concept.

FIG. 8 is a flowchart illustrating a process of providing broadcasting-based augmented reality contents according to still another embodiment of the inventive concept.

### DETAILED DESCRIPTION

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

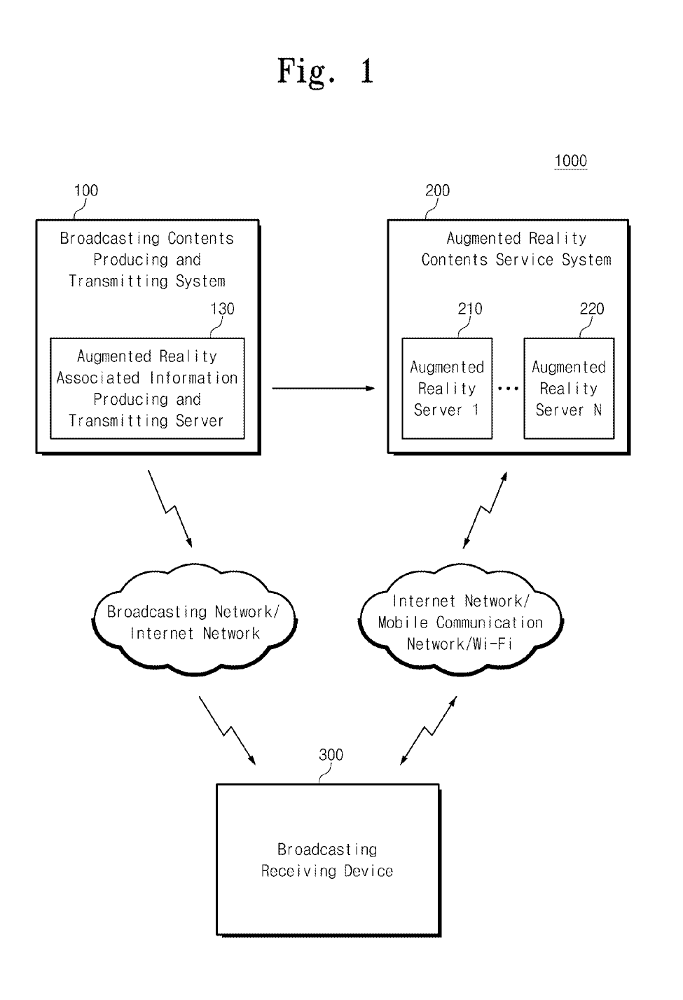

FIG. 1 is a block diagram schematically illustrating connection between systems for providing broadcasting-based augmented reality contents according to an embodiment of the inventive concept.

With an embodiment of the inventive concept, various augmented reality contents such as education, advertisement, game, map, Social Network Service (SNS), and the like may be bi-directionally provided based on moving pictures or broadcasting contents which are transmitted via a broadcasting network such as a terrestrial broadcasting, a DMB broadcasting, a satellite broadcasting, a cable broadcasting, an internet protocol television (IPTV), and the like or an internet network. As illustrated in FIG. 1, a system 1000 for providing broadcasting-based augmented reality contents may include a broadcasting contents producing and transmitting system 100, an augmented reality contents service system 200, and a broadcasting receiving device 300.

The broadcasting contents producing and transmitting system 100 may produce broadcasting contents such that augmented reality associated information is included in image data shot via an image shooting device. The broadcasting contents producing and transmitting system 100 may include an augmented reality associated information producing and transmitting server 130 that enables augmented reality associated information to be included in shot image data. The broadcasting contents producing and transmitting system 100 may transmit the produced broadcasting contents to a broadcasting receiving device via a broadcasting network or an internet network. Upon producing of broadcasting contents, the broadcasting contents producing and transmitting system 100 may provide the augmented reality contents service system 200 with the augmented reality associated information included in image data at producing of broadcasting contents.

For ease of description, one augmented reality contents service system 200 is illustrated in FIG. 1. However, it may be understood that a plurality of augmented reality contents service systems operated by augmented reality contents service providers is included in the system providing the broadcasting-based augmented reality contents.

The augmented reality contents service system 200 may include a plurality of augmented reality servers 210 and 220. Each of the augmented reality servers 210 and 220 may receive an augmented reality service request message from the broadcasting receiving device 300 and may make certification on the broadcasting receiving device 300 sending a message. Each of the augmented reality servers 210 and 220 may provide corresponding contents to the broadcasting receiving device 300 when certification is completed. The augmented reality contents service system 200 may further include a certification server which performs a certification procedure on the augmented reality service request message.

Each of the augmented reality servers 210 and 220 may provide different augmented reality contents. For example, the augmented reality server 210 may provide the broadcasting receiving device 300 with augmented reality contents associated with sightseeing-related broadcasting contents via an internet network, a mobile communication network, or a Wi-Fi. The augmented reality server 220 may provide the broadcasting receiving device 300 with augmented reality contents associated with map-related broadcasting contents via an internet network, a mobile communication network, or a Wi-Fi.

The broadcasting receiving device 300 may include a terminal device receiving broadcasting contents such as a television, a device (e.g., a DMB phone) receiving a DMB broadcasting, various set-top boxes (e.g., an internet protocol television (IPTV), an OTT, a smart television, and the like receiving a satellite broadcasting and a cable broadcasting), a smart phone, a smart pad, and the like.

The broadcasting receiving device 300 may include an augmented reality service agent for providing augmented reality contents. The augmented reality service agent of the broadcasting receiving device 300 may extract augmented reality associated information from received broadcasting contents and may request an augmented reality service to a corresponding augmented reality contents server 210 or 220. In this case, the augmented reality service request message may be sent to the augmented reality contents server 210 or 220 via an optimized network to which the broadcasting receiving device 300 is capable of being connected.

The system 1000 for providing broadcasting-based augmented reality contents may provide augmented reality contents as follows. The broadcasting contents producing and transmitting system 100 may produce broadcasting contents including augmented reality associated information to send it to the broadcasting receiving device 300.

The broadcasting receiving device 300 may send an augmented reality service request message to the augmented reality contents service system 200 according to the control of a user. The augmented reality contents service system 200 may certify the augmented reality service request message to search corresponding augmented reality contents. The augmented reality contents service system 200 may send the searched augmented reality contents to the broadcasting receiving device 300.

The broadcasting receiving device 300 may provide bi-directional augmented reality contents via a camera, which is installed therein or separated therefrom, and a reference marker. Herein, the reference marker may be transmitted from the augmented reality associated information producing and transmitting server 130 or an augmented reality server 210 or 220.

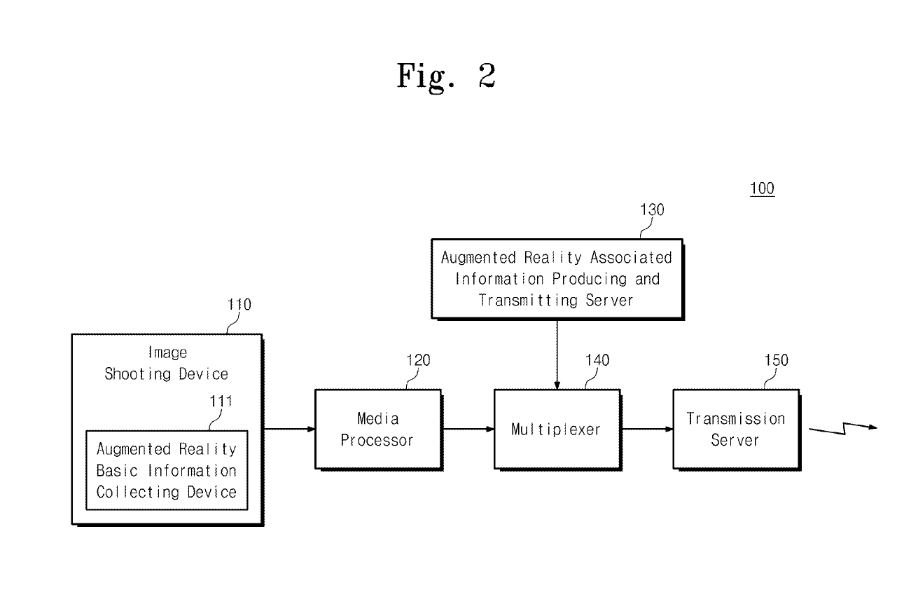

FIG. 2 is a block diagram schematically illustrating a broadcasting contents producing and transmitting system in FIG. 1. Referring to FIG. 2, a broadcasting contents producing and transmitting system 100 may include an image shooting device 110, a media processor 120, an augmented reality associated information producing and transmitting server 130, a multiplexer 140, and a transmission server 150.

The image shooting device 110 may be a device which can collect image and voice data (hereinafter, referred to as image data) such as a broadcasting camera. The image shooting device 110 may enable augmented reality basic information upon shooting of image data to be included in shot image data. Herein, the augmented reality basic information may indicate a position coordinate associated with the image shooting device 110, a direction, motion information, and the like.

The image shooting device 110 may include an augmented reality basic information collecting device 111 which to enable the augmented reality basic information to be included in shot image data. The augmented reality basic information collecting device 111 may include a GPS module, an acceleration sensor, a terrestrial magnetism sensor, a slope sensor, a gyroscope, a digital compass, and/or the like.

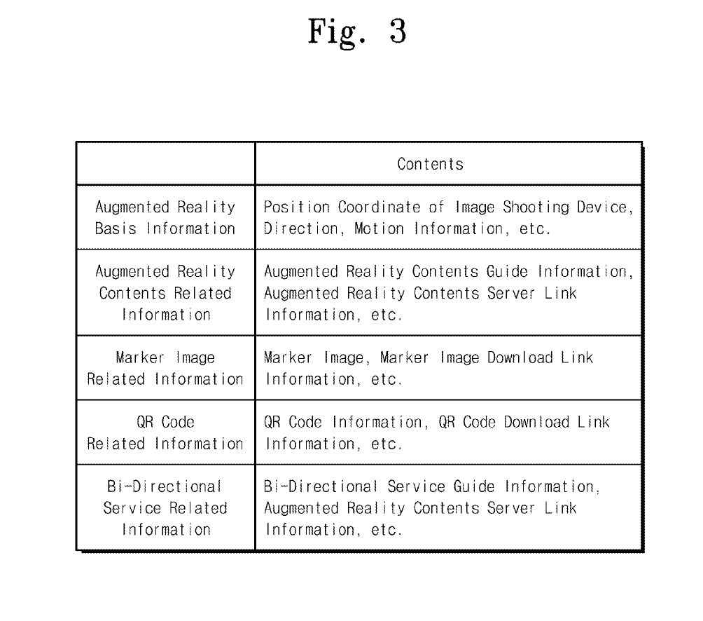

The augmented reality associated information producing and transmitting server 130 may produce augmented reality associated information to send it to the multiplexer 140. Herein, the augmented reality associated information will be more fully described with reference to FIG. 3. The augmented reality associated information producing and transmitting server 130 may synchronize the augmented reality associated information with an augmented reality contents server 210 or 220 (refer to FIG. 1) in real time.

With the above description, there is described the case that the augmented reality associated information is included in image data via the image shooting device 110. However, the augmented reality associated information can be included in image data via the augmented reality associated information producing and transmitting server 130.

The augmented reality associated information provided via the augmented reality associated information producing and transmitting server 130 may be included in image data transferred via the media processor 120 by the multiplexer 140. Broadcasting contents including the augmented reality associated information may be sent to a broadcasting receiving device 300 (refer to FIG. 1) via a transmission server 150.

FIG. 3 is a diagram for describing contents included in augmented reality associated information. Referring to FIG. 3, augmented reality associated information may include augmented reality basis information, augmented reality contents related information, maker image related information, a Quick Response (QR) code related information, and bi-directional service related information.

The augmented reality basis information may include a position coordinate of an image shooting device 110 (refer to FIG. 2), a direction, motion information, and the like. The augmented reality contents related information may include augmented reality contents guide information, augmented reality contents server link information, and the like. The marker image related information may include a marker image, marker image download link information, and the like. The QR code related information may include QR code information, QR code download link information, and the like. The bi-directional service related information may include bi-directional service guide information, augmented reality contents server link information, and the like.

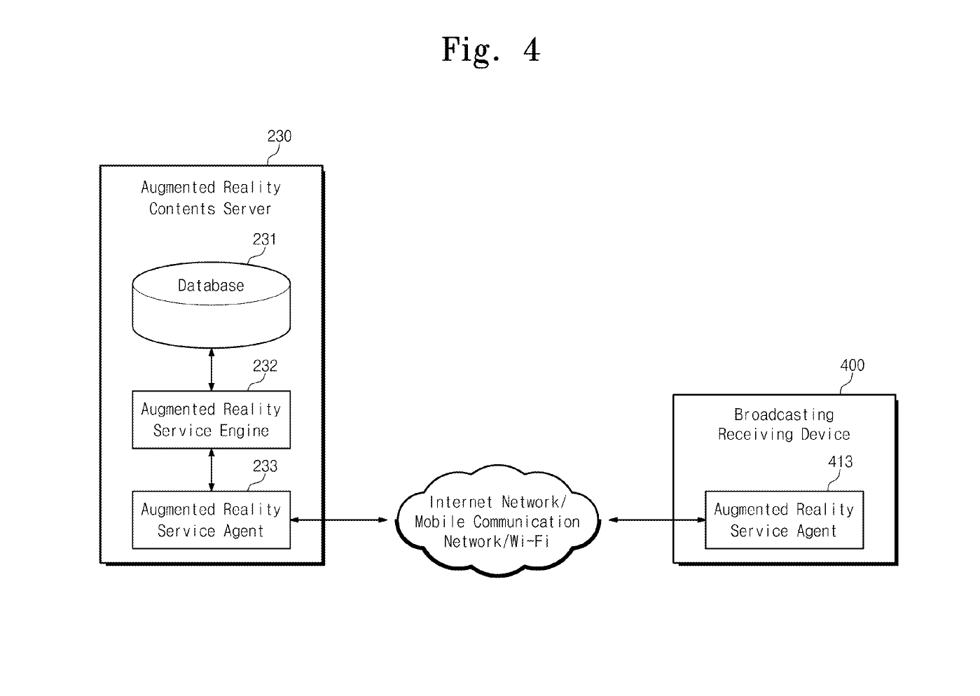

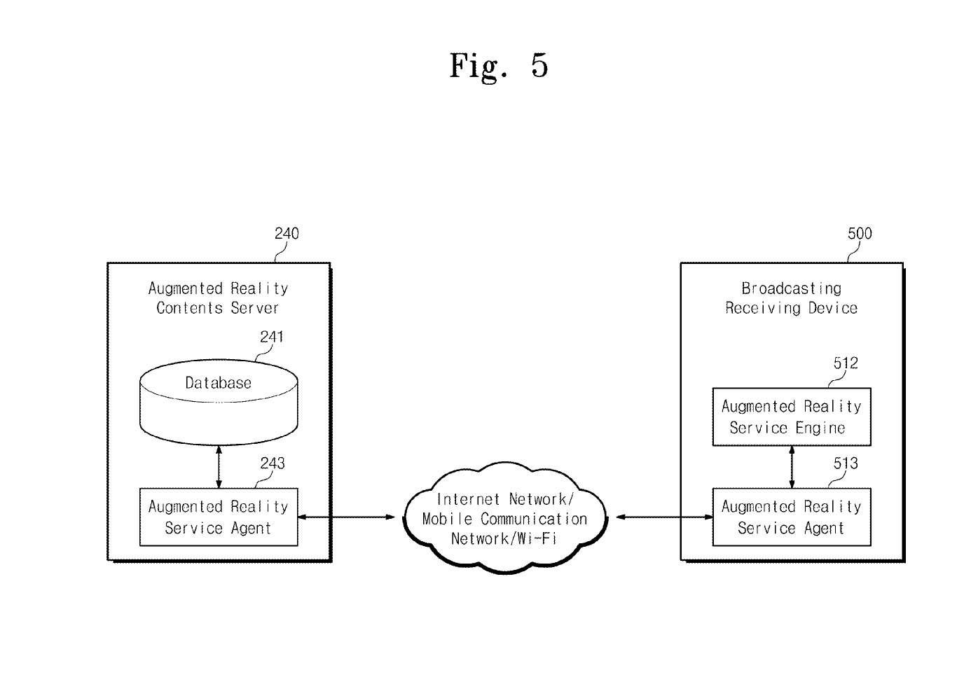

FIG. 4 is a block diagram schematically illustrating an augmented reality contents server and a broadcasting receiving device according to an embodiment of the inventive concept. FIG. 5 is a block diagram schematically illustrating an augmented reality contents server and a broadcasting receiving device according to another embodiment of the inventive concept. A principal agent of processing (e.g., rendering and the like) on augmented reality contents may differentiate according to configurations of an augmented reality contents server and a broadcasting receiving device.

Referring to FIG. 4, an augmented reality contents server 230 may include an augmented reality service engine 232, and a broadcasting receiving device 400 may not include an augmented reality service engine. In this case, processing (e.g., rendering and the like) on augmented reality contents may be made by the augmented reality contents server 230. That is, a construction in FIG. 4 may be an example of the cloud concept. With this construction, since processing on augmented reality contents is not made within the broadcasting receiving device 400, it is possible to simplify a hardware construction of the broadcasting receiving device 400. Further, this construction may be free from a power supply problem that is considered when the broadcasting receiving device 400 is a portable device.

Referring to FIG. 5, an augmented reality contents server 240 may not include an augmented reality service engine, and a broadcasting receiving device 500 may include an augmented reality service engine 512. In this case, processing (e.g., rendering and the like) on augmented reality contents may be made by the broadcasting receiving device 500. This construction may enable the broadcasting receiving device 500 to process augmented reality contents in real time. Further, with this construction, it is possible to effectively cope with a processing request on the augmented reality contents of a user that is generated frequently.

The construction of an augmented reality contents server and a broadcasting receiving device described in relation to FIGS. 4 and 5 may be decided according to concerns of an augmented reality service provider, a maker of a broadcasting receiving device, and the like.

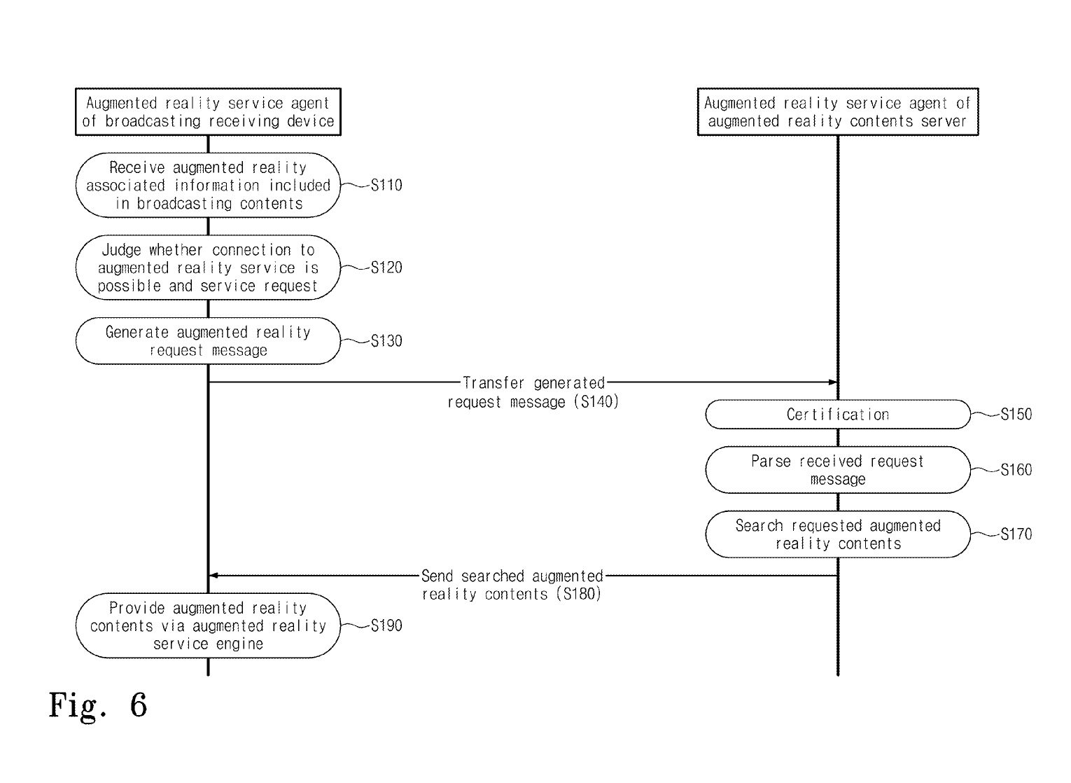

FIG. 6 is a flowchart illustrating a process of providing broadcasting-based augmented reality contents according to an embodiment of the inventive concept. FIG. 6 shows an associated process between an augmented reality service agent of a broadcasting receiving device and an augmented reality service agent of an augmented reality contents server.

In operation S110, an augmented reality service agent of a broadcasting receiving device may parse transmitted broadcasting contents to receive augmented reality associated information. That is, the augmented reality service agent of the broadcasting receiving device may judge whether augmented reality associated information is included within broadcasting contents. In a case where augmented reality associated information is included within broadcasting contents, in operation S120, the augmented reality service agent of the broadcasting receiving device may provide a user with whether connection to a augmented reality service is possible and related information, and may confirm a request on augmented reality service association of a user.

In the event that augmented reality service association is requested from a user, in operation S130, the augmented reality service agent of the broadcasting receiving device may generate an augmented reality service request message. In operation S140, the augmented reality service agent of the broadcasting receiving device may send the generated request message to the augmented reality service agent of the augmented reality contents server.

In operation S150, the augmented reality service agent of the augmented reality contents server may make certification processing on the sent request message. The augmented reality service agent of the augmented reality contents server may process certification on a broadcasting receiving device or a user requesting an augmented reality service using certification related information included in the augmented reality service request message. If the augmented reality contents being provided are free, the operation S150 may be skipped.

If certification is made successfully, in operation S160, the augmented reality service agent of the augmented reality contents server may parse the received augmented reality service request message. In operation S170, the augmented reality service agent of the augmented reality contents server may search corresponding augmented reality contents from the database based on information extracted from the request message.

In operation S180, the augmented reality service agent of the augmented reality contents server may send the searched augmented reality contents to the augmented reality service agent of the broadcasting receiving device. In operation S190, the broadcasting receiving device may provide augmented reality contents associated with broadcasting contents via an installed augmented reality service engine.

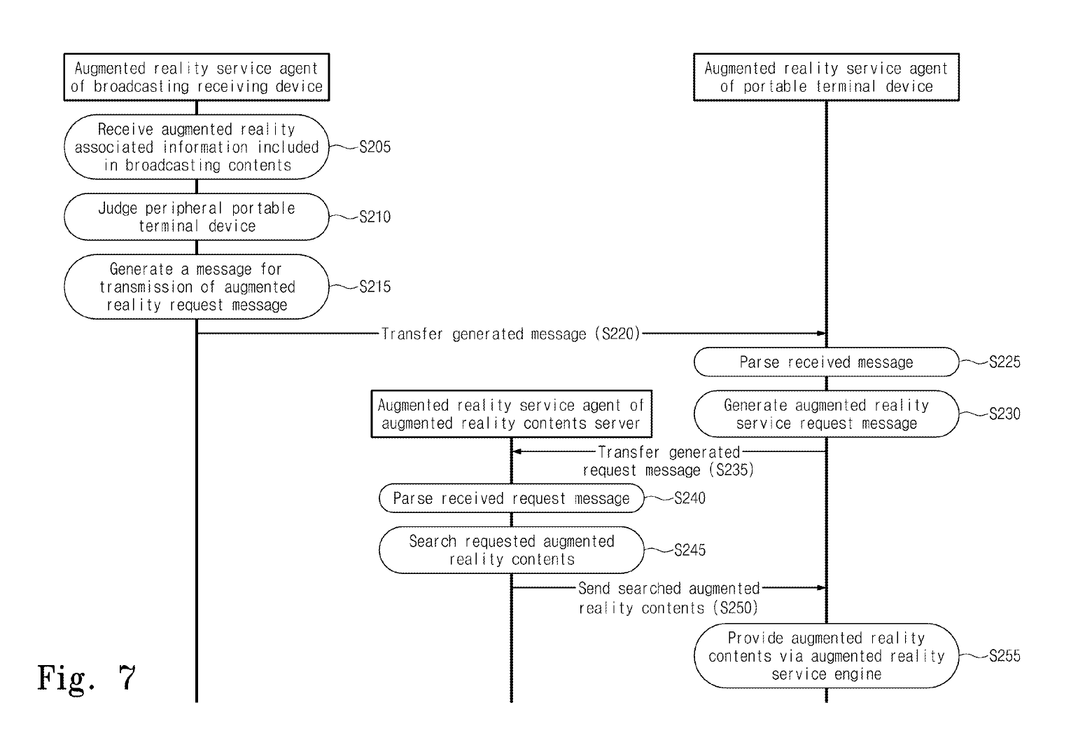

FIG. 7 is a flowchart illustrating a process of providing broadcasting-based augmented reality contents according to another embodiment of the inventive concept. FIG. 7 shows an associated process among an augmented reality service agent of a broadcasting receiving device, an augmented reality service agent of a portable broadcasting receiving device, and an augmented reality service agent of an augmented reality contents server.

In a broadcasting receiving device such as a television, if a specific user is provided with augmented reality contents, a user viewing at the same time may be hindered due to the augmented reality contents. With another embodiment of the inventive concept, augmented reality contents may be provided via a portable terminal device to solve the above-described problem.

In operation S205, the augmented reality service agent of the broadcasting receiving device may parse transmitted broadcasting contents to receive augmented reality associated information. That is, the augmented reality service agent of the broadcasting receiving device may check whether the augmented reality associated information is included in the broadcasting contents.

In a case where the augmented reality associated information is included in the broadcasting contents, in operation S210, the augmented reality service agent of the broadcasting receiving device may judge whether a portable terminal device exists around the broadcasting receiving device. Herein, the portable terminal device may be a terminal device capable of receiving both broadcasting contents and augmented reality contents or a terminal device capable of receiving augmented reality contents. The augmented reality service agent of the broadcasting receiving device may periodically check a portable terminal device placed at a peripheral area, and may update the result automatically.

In operation S215, the augmented reality service agent of the broadcasting receiving device may generate a message for sending augmented reality associated information. In operation S220, the augmented reality service agent of the broadcasting receiving device may send the generated message to the augmented reality service agent of the portable terminal device.

In operation S225, the augmented reality service agent of the portable terminal device may parse the received message to display whether connection to an augmented reality service is possible and related information to a user. In operation S225, the augmented reality service agent of the portable terminal device may check a request on augmented reality service association of the user.

If the augmented reality service association is requested from the user, in operation S230, the augmented reality service agent of the portable terminal device may generate an augmented reality service request message. In operation S235, the augmented reality service agent of the portable terminal device may send the generated request message to the augmented reality service agent of the augmented reality contents server. In operation S235, the generated request message may be sent via the augmented reality service agent of the broadcasting receiving device.

In operation S240, the augmented reality service agent of the augmented reality contents server may parse the received augmented reality service request message. It may be understood that prior to operation S240, the augmented reality service agent of the augmented reality contents server makes certification processing on the service request message.

In operation S245, the augmented reality service agent of the augmented reality contents server may search corresponding augmented reality contents from the database based on information extracted from the request message. In operation S250, the augmented reality service agent of the augmented reality contents server may send the searched augmented reality contents to the augmented reality service agent of the portable terminal device. In operation S255, the portable terminal device may provide augmented reality contents associated with broadcasting contents via an installed augmented reality service engine.

In the event that the portable terminal device does not include the augmented reality service engine and the broadcasting receiving device includes the augmented reality service engine, the augmented reality service agent of the augmented reality contents server may send the searched augmented reality contents to the augmented reality service agent of the broadcasting receiving device. The augmented reality service agent of the broadcasting receiving device may provide the portable terminal device with augmented reality contents via an installed augmented reality service engine.

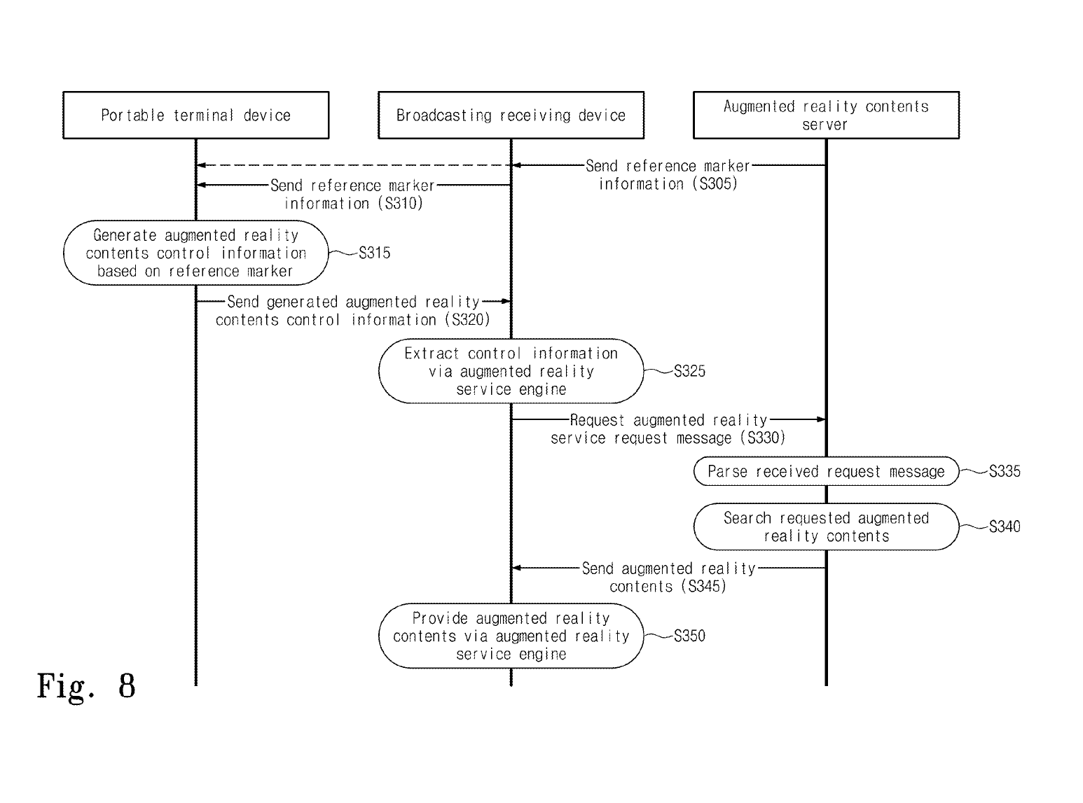

FIG. 8 is a flowchart illustrating a process of providing broadcasting-based augmented reality contents according to still another embodiment of the inventive concept. In FIG. 8, there is illustrated a procedure of generating and processing augmented reality contents control information using a portable terminal device.

To provide augmented reality contents based on a reference marker, control information on augmented reality contents may be collected by shifting a reference marker output on a paper upward and downward and right and left and shooting it using a camera, and the collected control information may be sent. This manner may accompany an inconvenient process of outputting a reference marker on a paper or obtaining an output reference marker. With still another embodiment of the inventive concept, the above-described problem may be solved by generating augmented reality contents control information via a portable terminal device.

In operation S305, an augmented reality contents server may send reference marker information to a broadcasting receiving device. As described above, the reference marker information may be information included in augmented reality associated information. The reference marker information may be formed of a marker image, a QR code, or the like. In operation S310, a broadcasting receiving device may send input reference marker information to a portable terminal device. The portable terminal device may include a mobile phone, a smart remote controller, a smart pad, or the like which is held by a user using the broadcasting receiving device. The portable terminal device may further comprise a display device (e.g., a liquid crystal display) for displaying images.

In FIG. 8, there is illustrated the case that reference marker information is sent to a portable terminal device via broadcasting receiving device. However, it may be understood that reference marker information is directly sent to a portable terminal device without passing through broadcasting receiving device

In operation S315, the portable terminal device may generate augmented reality contents control information based on a reference marker according to the control of a user. For example, a user may generate control information on augmented reality contents by moving the portable terminal device having a screen on which reference marker information is displayed. In operation S320, the generated control information may be received via a camera, and may be sent to the broadcasting receiving device. For example, a shape of a reference marker input via a camera may be sent to the broadcasting receiving device. Herein, the camera may be included in the portable terminal device or the broadcasting receiving device.

In operation S325, the broadcasting receiving device may extract control information by performing image processing on the reference marker via an installed augmented reality service engine. The extracted control information may be used as screen control information on augmented reality contents.

In operation S330, the broadcasting receiving device may generate an augmented reality service request message based on the extracted control information, and may send the generated request message. In operation S335, an augmented reality contents server may parse the input augmented reality service request message. It may be understood that prior to operation S3350, the augmented reality contents server makes certification processing on the service request message.

In operation S340, the augmented reality contents server may search corresponding augmented reality contents from the database based on information extracted from the request message. In operation S345, the augmented reality contents server may send the searched augmented reality contents to the broadcasting receiving device. In operation S350, the broadcasting receiving device may provide augmented reality contents associated with broadcasting via an installed augmented reality service engine.

With the above description, it is possible to provide a broadcasting receiving device or a portable terminal device with various augmented reality contents according to a request of a user based on moving pictures or broadcasting contents transferred via a broadcasting network or an internet network. Thus, it is possible to receive a bi-directional service request of a user on augmented reality contents, and a synergy may be generated according to the convergence between contents of broadcasting and augmented reality contents service providers.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A method of providing broadcasting-based augmented reality contents, comprising:
judging whether received broadcasting contents include augmented reality associated information;
requesting an augmented reality service based on the augmented reality associated information; and
providing augmented reality contents according to the request.

2. The method of claim 1, further comprising:
providing information indicating that connection to the augmented reality service is possible, based on the augmented reality associated information; and
confirming a request on the connection to the augmented reality service.

3. The method of claim 1, further comprising:
making certification on the request.

4. The method of claim 1, further comprising:
searching the augmented reality contents corresponding to the request.

5. The method of claim 1, further comprising:
adding the augmented reality associated information to the broadcasting contents.

6. The method of claim 1, further comprising:
searching a portable terminal device around a broadcasting receiving device receiving the broadcasting contents.

7. The method of claim 6, further comprising:
sending the augmented reality associated information to the searched portable terminal device.

8. The method of claim 7, wherein the requesting is performed by the portable terminal device.

9. A method of providing broadcasting-based augmented reality contents, comprising:
providing reference marker information to a portable terminal device;
generating control information on the augmented reality contents according to the provided reference marker information;
receiving and sending the control information; and
requesting an augmented reality service based on the control information.

10. The method of claim 9, further comprising:
adding augmented reality associated information including the reference marker information to broadcasting contents.

11. The method of claim 9, further comprising:
searching the augmented reality contents corresponding to the request.

12. The method of claim 11, further comprising:
providing the searched augmented reality contents.

13. The method of claim 12, wherein the generating control information comprises:
displaying the provided reference marker information using the portable terminal device; and
moving the portable terminal device.

14. The method of claim 13, wherein the receiving and sending comprises:
receiving an image of the reference marker information using a camera.

15. A system of providing broadcasting-based augmented reality contents, comprising:
a broadcasting contents producing and transmitting device configured to add augmented reality associated information to broadcasting contents;
an augmented reality contents service device configured to receive the augmented reality associated information from the broadcasting contents producing and transmitting device and to provide augmented reality contents corresponding to the augmented reality associated information; and
a broadcasting receiving device configured to receive broadcasting contents to which the augmented reality associated information is added and to receive the augmented reality contents from the augmented reality contents service device.

16. The system of claim 15, wherein the broadcasting receiving device sends the augmented reality associated information to a portable terminal device placed around the broadcasting receiving device; and
wherein the portable terminal device requests the augmented reality contents to the augmented reality contents service device and receives the requested augmented reality contents from the augmented reality contents service device.

17. The system of claim 16, wherein the portable terminal device requests the augmented reality contents via the broadcasting receiving device and receives the augmented reality contents.

18. The system of claim 15, wherein the broadcasting receiving device provides reference marker information provided from the augmented reality contents service device to a portable terminal device placed around the broadcasting receiving device; and
wherein the portable terminal device provides control information on the augmented reality contents to the augmented reality contents service device according to the provided reference marker information.

19. The system of claim 18, wherein the control information on the augmented reality contents is sent via the broadcasting receiving device.

20. The system of claim 18, wherein the augmented reality contents service device provides augmented reality contents searched according to the control information on the augmented reality contents.
